(19) United States
(12) Patent Application Publication
(10) Pub. No.: US 2023/0292703 A1
(43) Pub. Date: Sep. 21, 2023

(54) FEEDER

(71) Applicant: Doskocil Manufacturing Company, Inc., Arlington, TX (US)

(72) Inventors: Michael HARPER, Fort Worth, TX (US); Ryan PAXSON, Elk Rapids, MI (US); David VENESS, Fort Worth, TX (US)

(21) Appl. No.: 18/104,163

(22) Filed: Jan. 31, 2023

Related U.S. Application Data
(60) Provisional application No. 63/322,033, filed on Mar. 21, 2022.

(51) Int. Cl. A01K 5/01

(52) U.S. Cl. CPC A01K 5/0114

(57) ABSTRACT

A pet food feeder includes a base, a hopper, a bowl and a food dispensing mechanism. The hopper holds foodstuffs. The hopper is detachably supported to the base. The bowl for receives foodstuffs from the hopper via the base. The food dispensing mechanism is supported to the base. The food dispensing mechanism is rotatable with respect to the base to dispense foodstuffs from the hopper to the bowl in predetermined increments.

### BACKGROUND

### Technical Field

The present disclosure generally relates to a feeder. More specifically, the present disclosure relates to a feeder for manually dispensing foodstuffs, Background Information

Pet feeders can dispense foodstuffs and/or liquid from a storage container either manually or automatically. Conventional pet feeders include a storage area that is a container or a hopper and a bowl that is operatively connected to the hopper to receive foodstuffs or contents contained in the hopper.

### SUMMARY

In view of the state of the known technology, one aspect of the present disclosure is to provide a pet food feeder comprising a base, a hopper, a bowl and a food dispensing mechanism. The hopper holds foodstuffs. The hopper is detachably supported to the base. The bowl receives foodstuffs from the hopper via the base. The food dispensing mechanism is supported to the base. The food dispensing mechanism is rotatable with respect to the base to dispense foodstuffs from the hopper to the bowl in predetermined increments.

Embodiments of the present invention improve portion control for feeding pets and prolong food viability due to the rotatable dispensing mechanism.

### BRIEF DESCRIPTION OF THE DRAWINGS

Referring now to the attached drawings which form a part of this original disclosure:

FIG. 1 is a perspective view of a pet food feeder that includes a howl, a base and a hopper in accordance with an illustrated embodiment;

FIG. 2 is a first side view of the pet food feeder showing an operating knob of the base that is rotated in order to deliver foodstuff form the hopper to the bowl in accordance with the illustrated embodiment;

FIG. 3 is a second side view of the pet food feeder in accordance with the illustrated embodiment;

FIG. 4 is a front view of the pet food feeder in accordance with the illustrated embodiment;

FIG. 5 is a rear view of the pet food feeder showing a slide lock in a locked position locking the hopper to the base in accordance with the illustrated embodiment;

FIG. 6 is a top view of the pet food feeder in accordance with the illustrated embodiment;

FIG. 7 is a bottom view of the pet food feeder in accordance with the illustrated embodiment,

FIG. 8 is an exploded perspective view of the pet food feeder showing the bowl, the base, elements of a food dispensing mechanism, the slide lock, the hopper, a lid and a gasket in accordance with the illustrated embodiment;

FIG. 9 is a perspective view of the bowl removed from the pet food feeder in accordance with the illustrated embodiment;

FIG. 10 is a perspective view of the base with the food dispensing mechanism removed showing a concaved top surface with a spinner receiving portion, shaft receiving portions, a shaft lock receiving recess and latch openings in accordance with the illustrated embodiment;

FIG. 11 is an exploded perspective view of the base showing the elements of the food dispensing mechanism in accordance with the illustrated embodiment;

FIG. 12 is another perspective view of the base showing the elements of the food dispensing mechanism installed to the base in accordance with the illustrated embodiment;

FIG. 13 is a cross-sectional side view of the pet food feeder similar to FIG. 2 showing a spinner of the food dispensing mechanism of the base that can be rotated to measure and release food stuffs from the hopper to the bowl in accordance with the illustrated embodiment;

FIG. 14 is a cross-sectional front view of the pet food feeder similar to FIG. 4 showing the spinner of the food dispensing mechanism of the base in accordance with the illustrated embodiment;

FIG. 15 is a perspective side view of a portion of the base and the hopper with the knob of the food dispensing mechanism showing a clicker mechanism that makes a noise in response to rotation of the knob and a shaft of the food dispensing mechanism by a pet owner in accordance with the illustrated embodiment;

FIG. 16 is a perspective view of the shaft removed from the feeder in accordance with the illustrated embodiment;

FIG. 17 is a side view of the shaft removed from the feeder in accordance with the illustrated embodiment,

FIG. 18 is a perspective view of the spinner removed from feeder in accordance with the illustrated embodiment;

FIG. 19 is a side view of the spinner removed from the feeder in accordance with the illustrated embodiment:

FIG. 20 is a perspective view of one side of the knob removed from the shaft and the feeder in accordance with the illustrated embodiment;

FIG. 21 is a side view of the knob removed from the shaft and the feeder in accordance with the illustrated embodiment;

FIG. 22 is a cross-sectional view of the knob showing projections that contact the clicker mechanism depicted in FIG. 15 in accordance with the illustrated embodiment;

FIG. 23 is a perspective view of another side of the knob showing the projections that contact the clicker mechanism depicted in FIG. 15 in accordance with the illustrated embodiment;

FIG. 24 is a perspective view of a shaft lock removed from the base in accordance with the illustrated embodiment;

FIG. 25 is a side view of the shaft lock removed from the base in accordance with the illustrated embodiment;

FIG. 26 is a top view of a portion of the concaved top surface of the base showing the shaft lock in an unlocked position such that the shaft and the shaft lock can be removed from the base for cleaning in accordance with the illustrated embodiment;

FIG. 27 is another top view of the portion of the concaved top surface of the base similar to FIG. 26 showing the shaft lock in a locked position such that the shaft and the shaft lock are held in the shaft receiving portions of the base in accordance with the illustrated embodiment;

FIG. 28 is a cross-sectional side view of the portion of the concaved top surface of the base showing the shaft lock in the unlocked position such that the shaft and the shaft lock can be removed from the shaft receiving portions of the base for cleaning in accordance with the illustrated embodiment;

FIG. 29 is another cross-sectional side view of the portion of the concaved top surface of the base similar to FIG. 28 showing the shaft lock in a locked position such that the shaft and the shaft lock are held in the shaft receiving portions of the base in accordance with the illustrated embodiment;

FIG. 30 is a cross-sectional side view of a portion of the base showing a wheel of the shaft with recesses in the wheel contacting a flexible projection providing a means for retaining the wheel and shaft in predetermined positions corresponding to positions of fins of the spinner of the food dispensing mechanism in accordance with the illustrated embodiment;

FIG. 31 is a perspective view of the hopper removed from the base and bowl and with the lid removed showing a floor with a first opening, an overfeed barrier, a safety lip and base contacting hooks in accordance with the illustrated embodiment;

FIG. 32 is a top view of the hopper removed from the base and bowl showing the floor with the first opening, the overfeed barrier and the safety lip in accordance with the illustrated embodiment;

FIG. 33 is another perspective view of the hopper from an angle different compared to FIG. 31 showing the floor with the first opening, the overfeed barrier, the safety lip and the base contacting hooks in accordance with the illustrated embodiment;

FIG. 34 is a side view of the hopper showing the floor with the overfeed barrier, one of the fins from the spinner, the safety lip and the base contacting hooks in accordance with the illustrated embodiment;

FIG. 35 is a front view of the hopper showing the floor with the overfeed barrier, the safety lip and the base contacting hooks in accordance with the illustrated embodiment;

FIG. 36 is a perspective view of a gasket that is installed between the top of the hopper and the lid of the hopper in accordance with the illustrated embodiment;

FIG. 37 is a perspective view of the lid of the hopper the lid having a pair of latch receiving recessed areas in accordance with the illustrated embodiment;

FIG. 38 is a top perspective view of a latch of the lid in accordance with the illustrated embodiment;

FIG. 39 is a bottom perspective view of the latch depicted in FIG. 38 in accordance with the illustrated embodiment;

FIG. 40 is a perspective view of a slide lock of the base in accordance with the illustrated embodiment;

FIG. 41 is a rear view of the slide lock depicted in FIG. 40 in accordance with the illustrated embodiment;

FIG. 42 is a side view of the slide lock in accordance with the illustrated embodiment; and

FIG. 43 is a side view of a portion of the feeder showing the spinner and the shaft installed to the base with the hopper installed to the base and further showing direction of flow of foodstuff being selectively released from the hopper to the bowl in accordance with the illustrated embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

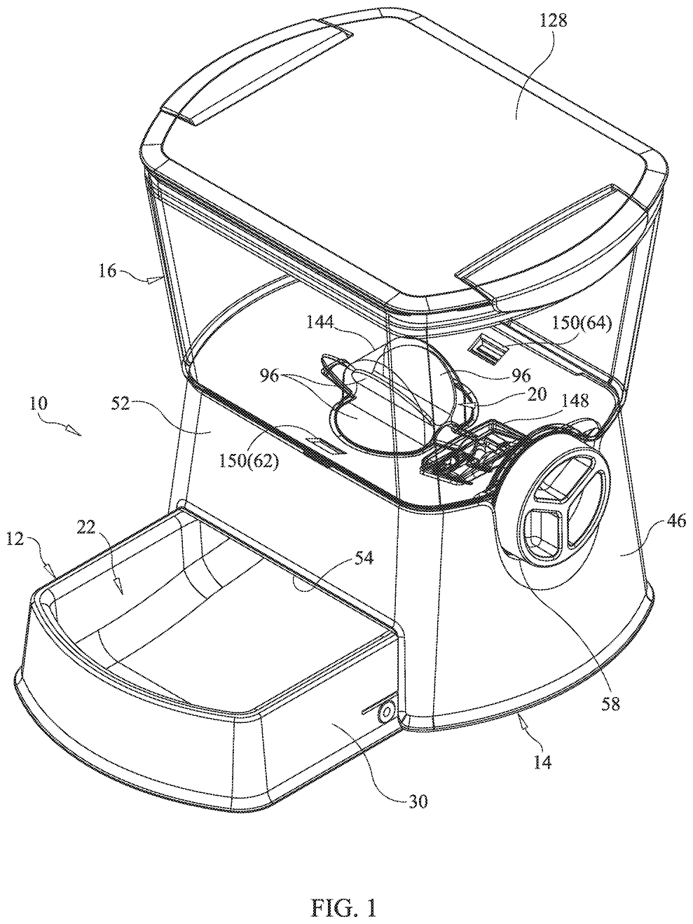

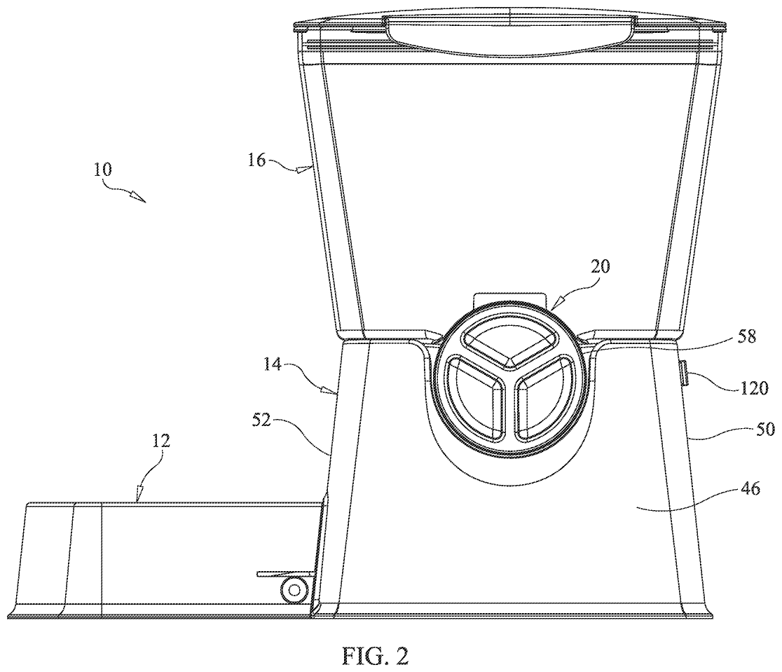

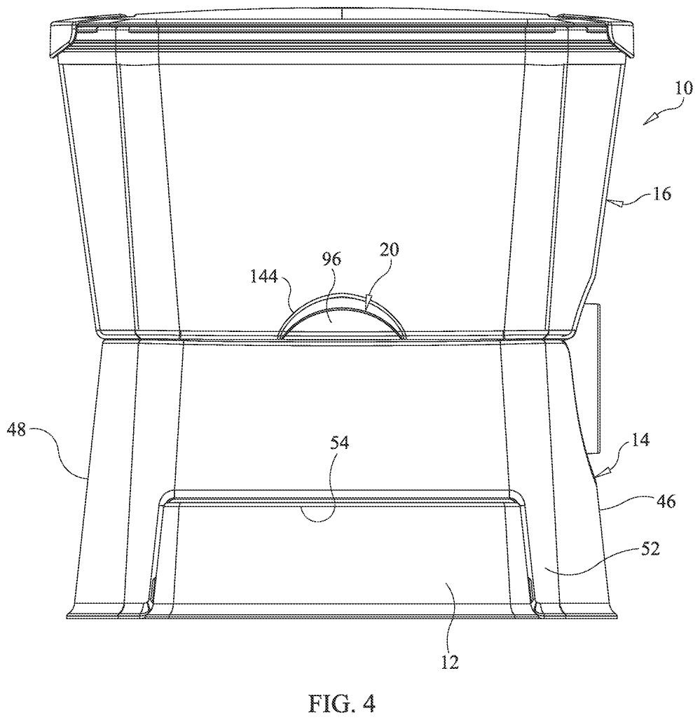

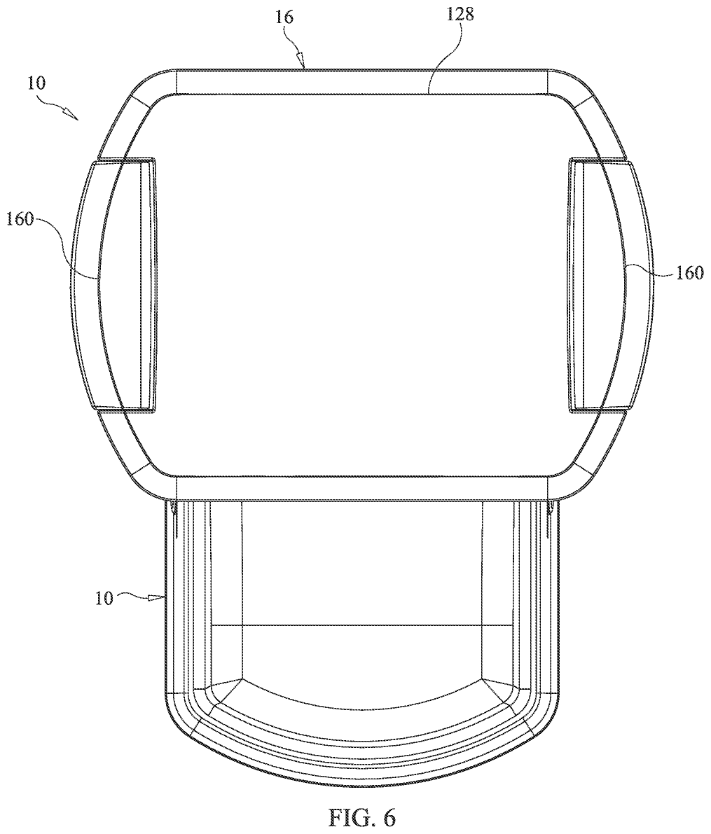

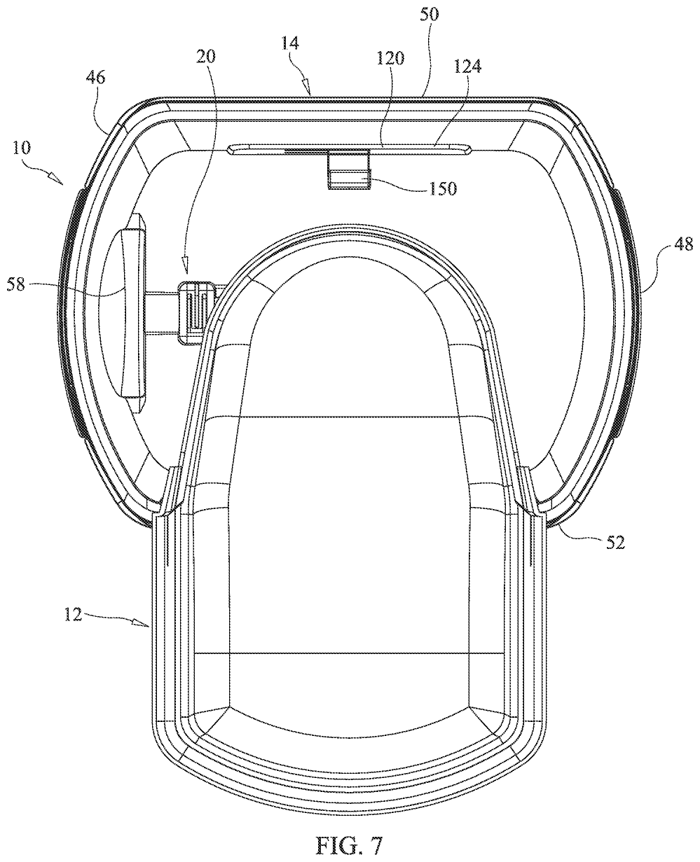

Referring initially to FIGS. 1-8, a pet food feeder 10 is depicted in accordance with an illustrated embodiment.

The pet food feeder 10 (hereinafter the feeder 10) includes a bowl 12, a base 14 and a hopper 16. The base 14 supports the hopper 16. The hopper 16 is a container for storing solid foodstuffs, semi-solid foodstuffs (soft foodstuffs) or liquids. A portion of the bowl 12 extends beneath the base 14 to receive contents stored in the hopper 16 (also referred to as a container).

The feeder 10 is designed to dispense pet food, foodstuffs and/or fluid that is stored in the hopper 16 to the bowl 12. The feeder 10 is a manual feeder that is designed to be manually operated to dispense foodstuffs from the hopper 16 to the bowl 12. In particular, the feeder 10 includes a food dispensing mechanism 20 that is installed to the base 14, as described in greater detail below. The food dispensing mechanism 20 includes rotatable parts that are movably supported to the base 14 to dispense food from the hopper 16 to the bowl 12. The food dispensing mechanism 20 is manually operated by a pet owner or pet handler, as will be further described. That is, the food dispensing mechanism 20 of the illustrated embodiment requires user operation for manual portion control and does not operate automatically.

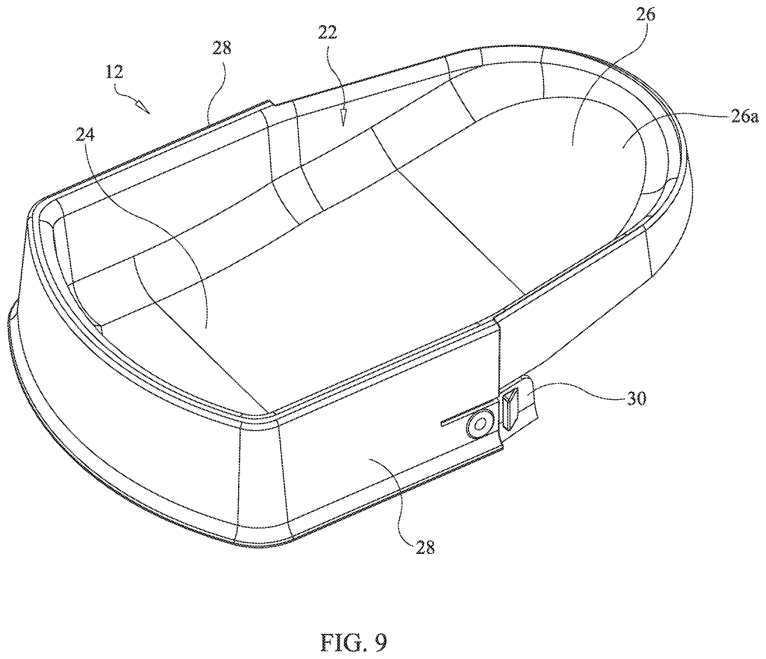

As shown in FIGS. 1, 8 and 9, the bowl 12 defines a concaved area 22 (a foodstuff retaining area) that includes a main area 24 and an inclined area 26 with a sloping or inclined surface 26a. Lower ends of side walls 28 of the bowl 12 include elastically deformable latching projections 30 (only one shown) that are dimensioned and shaped to engage and be retained by a corresponding area of the base 14, as described further below, thereby holding the bowl 12 to the base 14. The concaved area 22 of the bowl 12 can be dimensioned to hold a variety of differing amounts of foodstuff. For example, in the illustrated embodiment, the concaved area 22 is dimensioned to retain approximately 4.5 cups of food stuff (approximately 67 cubic inches of foodstuff). However, the bowl 12 and its concaved area 22 can be dimensioned to hold a greater amount of food stuff or a lesser amount of food stuff depending upon the desired size of the feeder 10. Specifically, for a pet owner with a large dog, a larger sized bowl 12 and larger capacity feeder 10 is desirable. A pet owner with a small cat will desire a smaller feeder 10 with a bowl 12 having smaller overall dimensions and capacity.

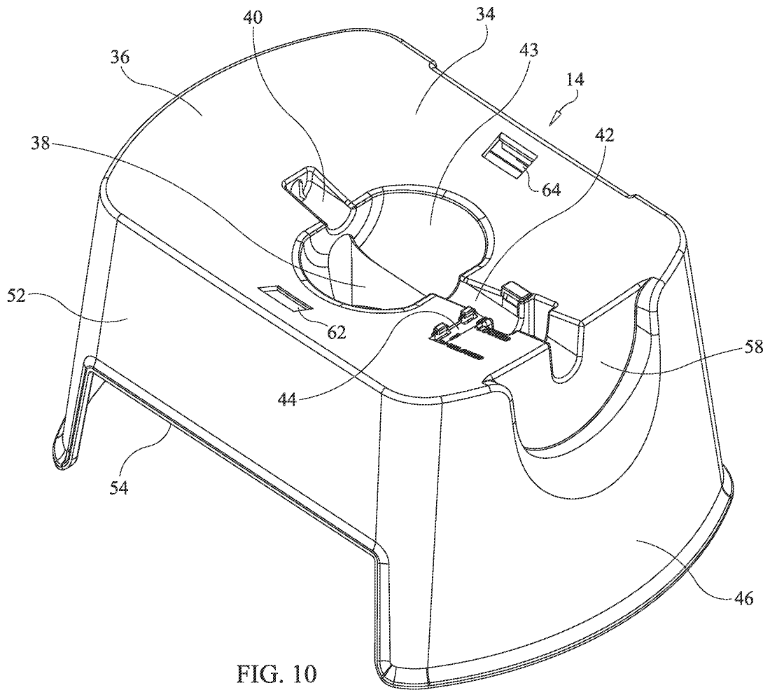

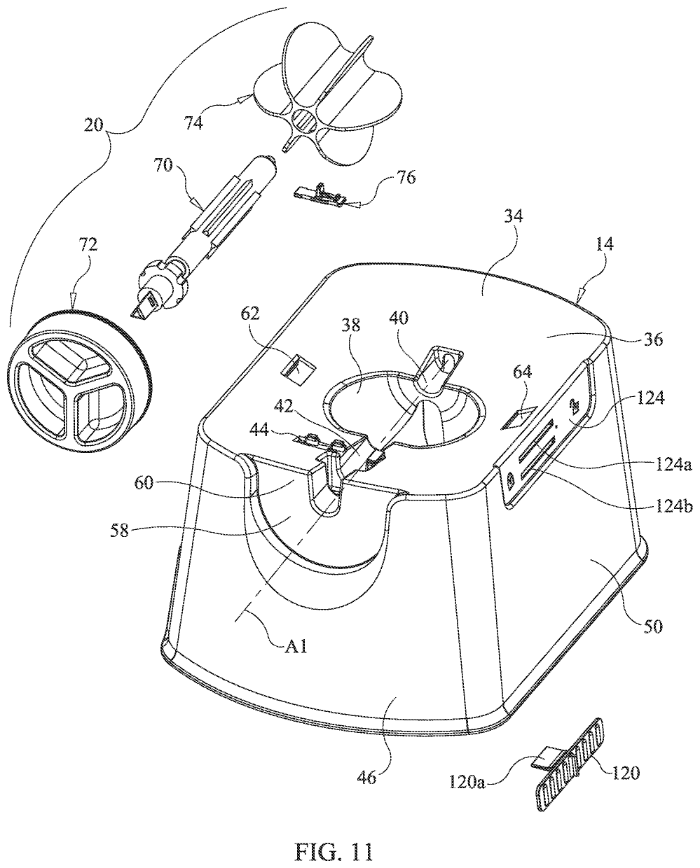

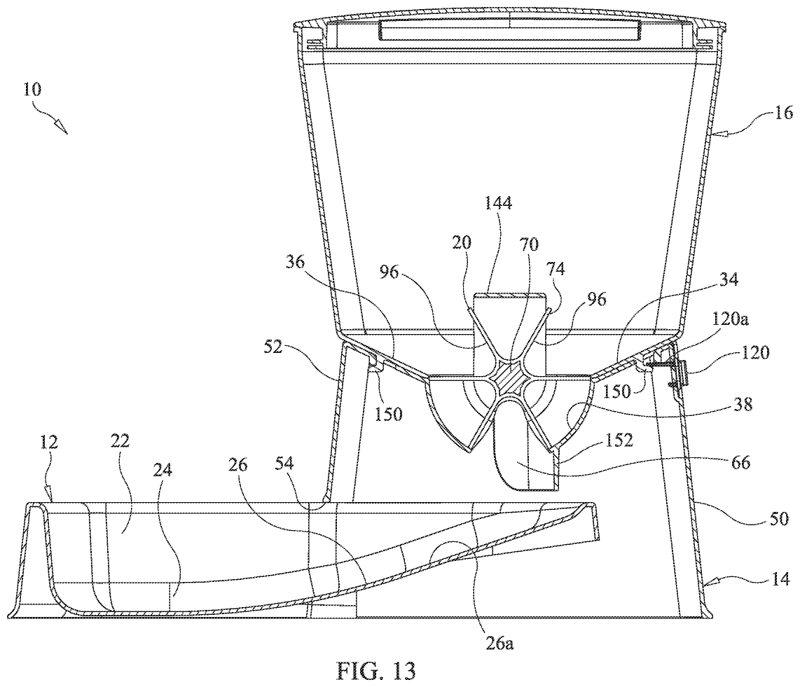

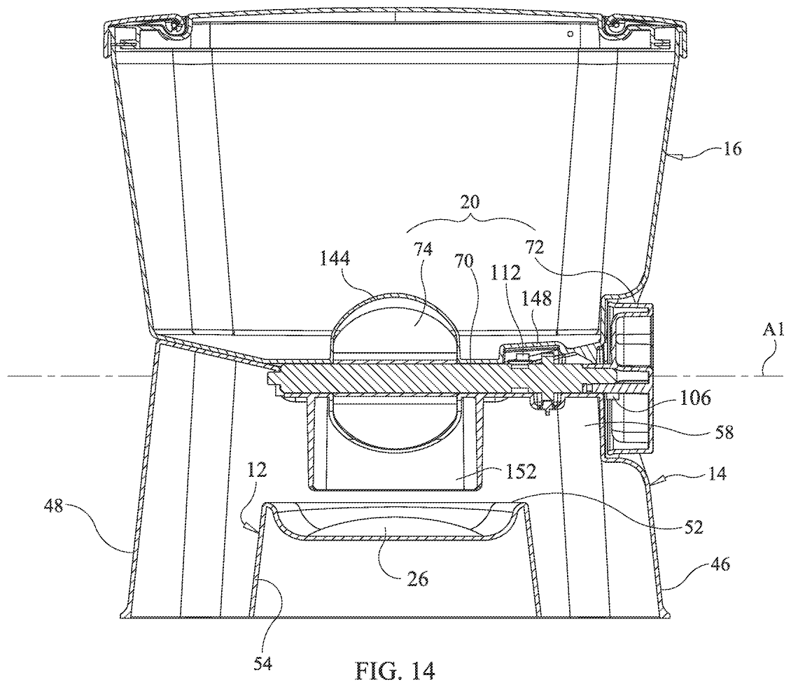

As shown in FIGS. 1-8 and 10-15, the base 16 serves as a stand or main support structure for the hopper 16 and attaches to the bowl 12. The base 16 includes a top surface 34 that is concaved thereby defining a receptacle 36. The receptacle 36 is concaved and includes a concaved spinner receiving portion 38 and shaft receiving portions 40 and 42. The spinner receiving portion 38 is sized and dimensioned to receive a portion of the food dispensing mechanism 20, as described below. The spinner receiving portion 38 has a semi-spherical shape as shown in FIG. 13. The shaft receiving portions 40 and 42 are located on opposite sides of the spinner receiving portion 38 and are axially aligned with one another, as shown in FIGS. 10 and 11. Put differently, the shaft receiving portions 40 and 42 define a rotation axis A₁ that extends through both shaft receiving portions 40 and 42. The spinner receiving portion 38 is also axially aligned with the rotation axis A₁. The top surface 34 includes a lock receiving recess 44 that is described further below.

The base 14 has a first side wall 46, a second side wall 48 opposite the first side wall 46, a rear wall 50 and a front wall 52 that extend downward from corresponding edges of the top surface 34. The first side wall 46, the second side 48, the rear wall 50 and the front wall 52 extend around and downward from the top surface 34. The area beneath the top surface 34 and surrounded by the first side wall 46, the second side 48, the rear wall 50 and the front side 52 is hollow. The front side 52 has an opening 54 that receives a portion of the bowl 12 such that the portion of the bowl 12 is located beneath the spinner receiving portion 38, as shown in FIG. 13.

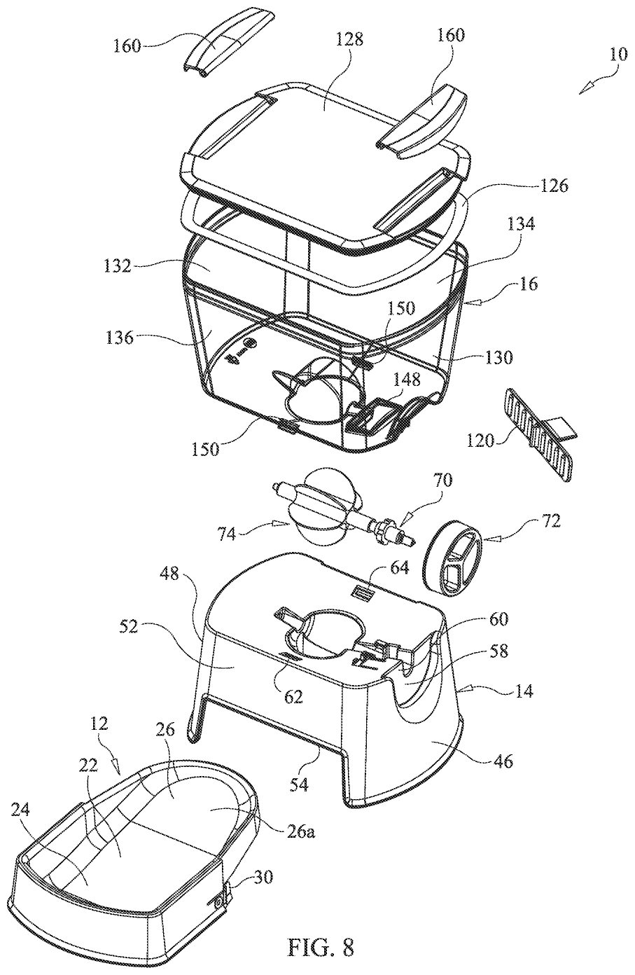

The shaft receiving portion 42 extends from the spinner receiving portion 38 to a knob receiving section 58 that is located along the first side wall 46 of the base 14. As shown in FIGS. 8, 10 and 15, the knob receiving section 58 is a concaved area or recessed area of the side wall 46 that is dimension to receive a knob 72, that is described below. The knob receiving section 58 further includes a clicker receiving section 60 that is a further concaved or recessed area that is described below.

As shown in FIGS. 10-12 and 15, the top surface 34 of the base 14 also includes latch openings 62 and 64 that are provided for securing the hopper 16 to the base 14, as described below.

The lower areas of the front wall 52 on either side of the opening 54 are dimensioned and shaped to receive respective ones of the latching projections 30 thereby securing the bowl 12 to the base 14. By pressing on the latching projections 30 of the bowl 12, the bowl 12 can be removed from the base 14 for disassembly and/or cleaning.

The bowl 12 is attached to the base 14 such that the main area 24 of the bowl 12 extends outward and away from the front wall 52. The inclined area 26 is located within the hollow area of the base 14 when installed and extends under the spinner receiving portion 38, as shown in FIG. 13.

As best seen in FIG. 13, the base 14 includes an opening 66 that extends from the spinner receiving section 38 to the inclined area 26 of the bowl 12. As is described below, when foodstuff is released from the hopper 16 by the food dispensing mechanism 20, the foodstuff within the spinner receiving section 38 passes or falls through the opening 66 into the bowl 12.

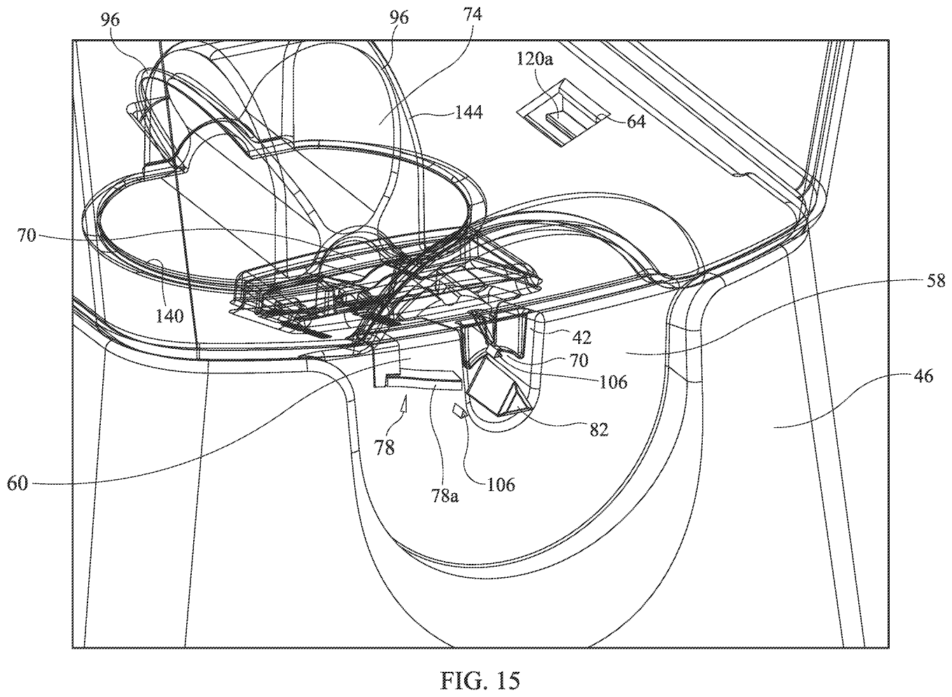

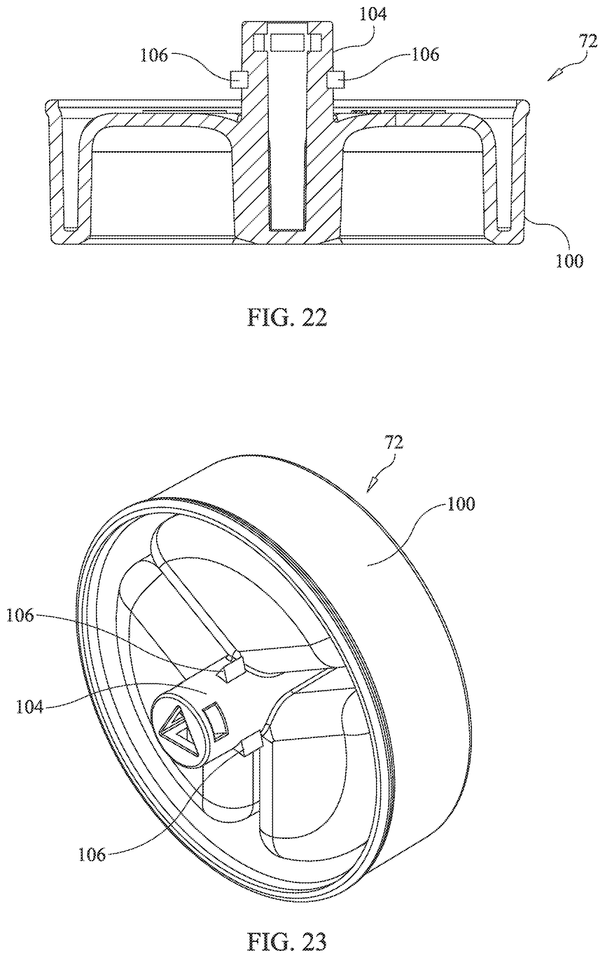

A description of the food dispensing mechanism 20 is now provided with reference to FIGS. 8 and 11-25. The food dispensing mechanism 20 is a portion control mechanism that includes a shaft 70, a knob 72, a spinner 74, a shaft lock 76 and a clicker 78 (FIG. 15).

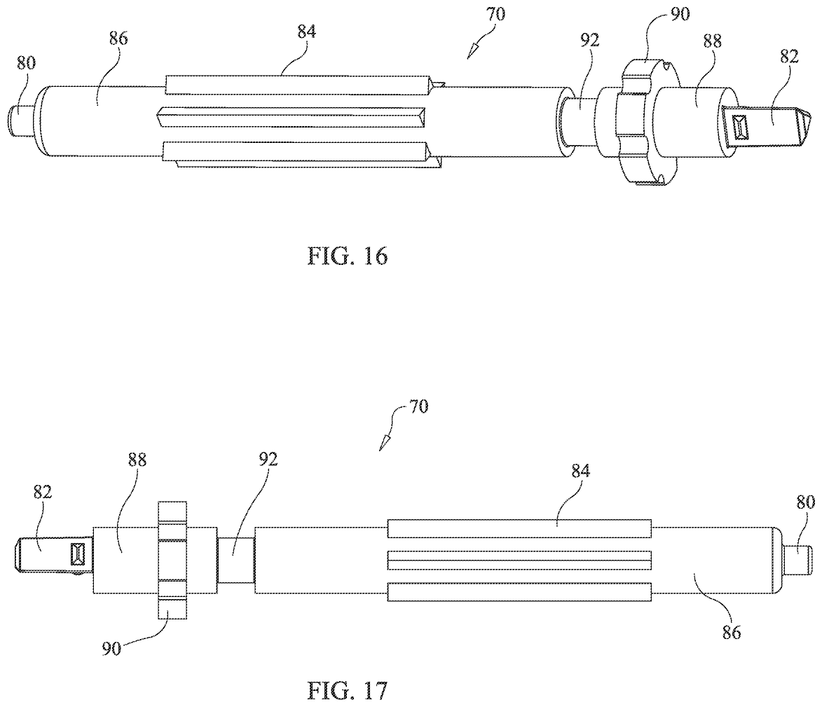

As shown in FIGS. 16 and 17, the shaft 70 has a first end 80, a second end 82, splines 84, bearing sections 86 and 88, a wheel 90 (also referred to as a boss 90) that is either fixed to the shaft 70 or formed therewith and a locking area 92.

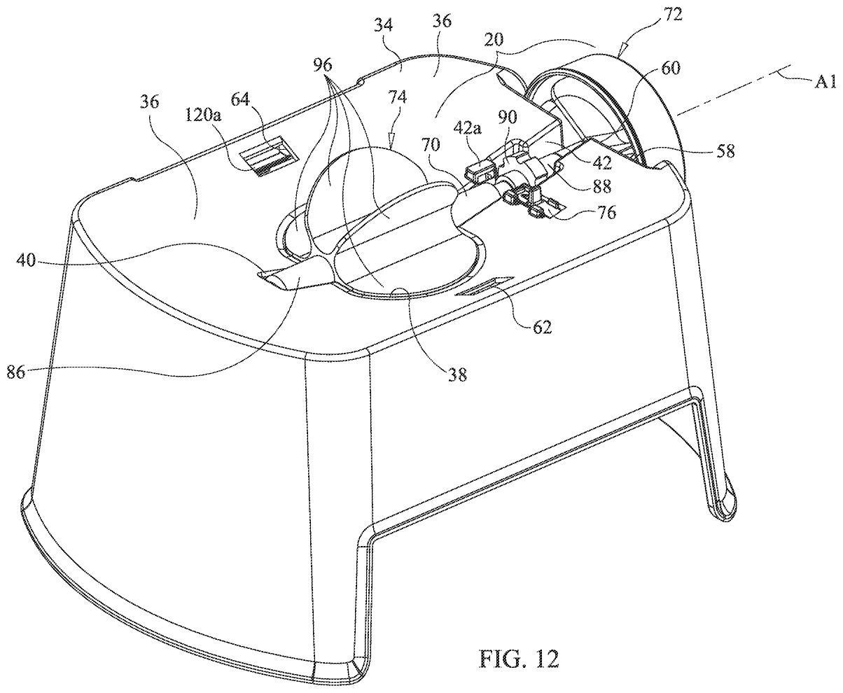

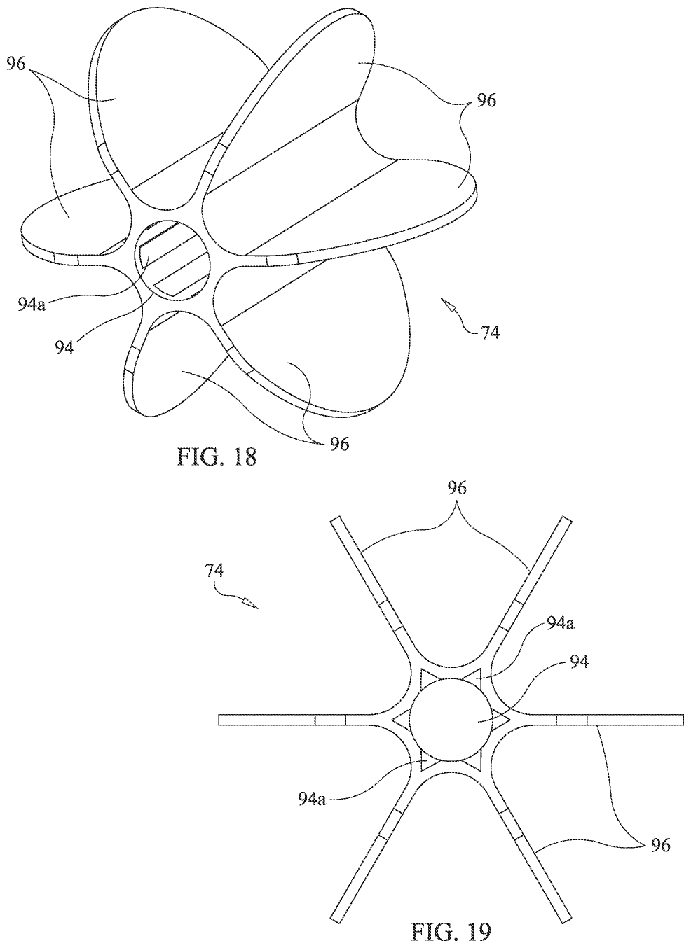

As shown in FIG. 18, the spinner 74 has a central opening 94 and fins 96 (also referred to as paddles 96). The central opening 94 includes recesses 94a that mate with the splines 84 of the shaft 70. Hence, the splines 84 of the shaft 70 defines a spinner support portion. As shown in FIGS. 8 and 12, the spinner 74 is fixedly attached to the shaft 70 with the recesses 94a of the opening 94 being in firm engagement with the splines 84 and the shaft 70. The spinner 74 can be press-fitted onto the shaft 70. The fins 96 of the spinner 74 have a curved, semi-circular shape that fits within the spinner receiving portion 38 of the base 14, as shown in FIGS. 8 and 12-14, The spinner 74 can also be formed by over-molding onto the shaft 70. Preferably, the shaft 70 is made of made of a rigid polymer, plastic or resin-based material manufactured using a molding process. The spinner 72 and in particular the fins 96, are made of silica rubber or other type of elastic material that is more flexible than the material used to manufacture the shaft 70 in order to prevent or limit bruising or crushing of the foodstuff passing through the food dispensing mechanism 20.

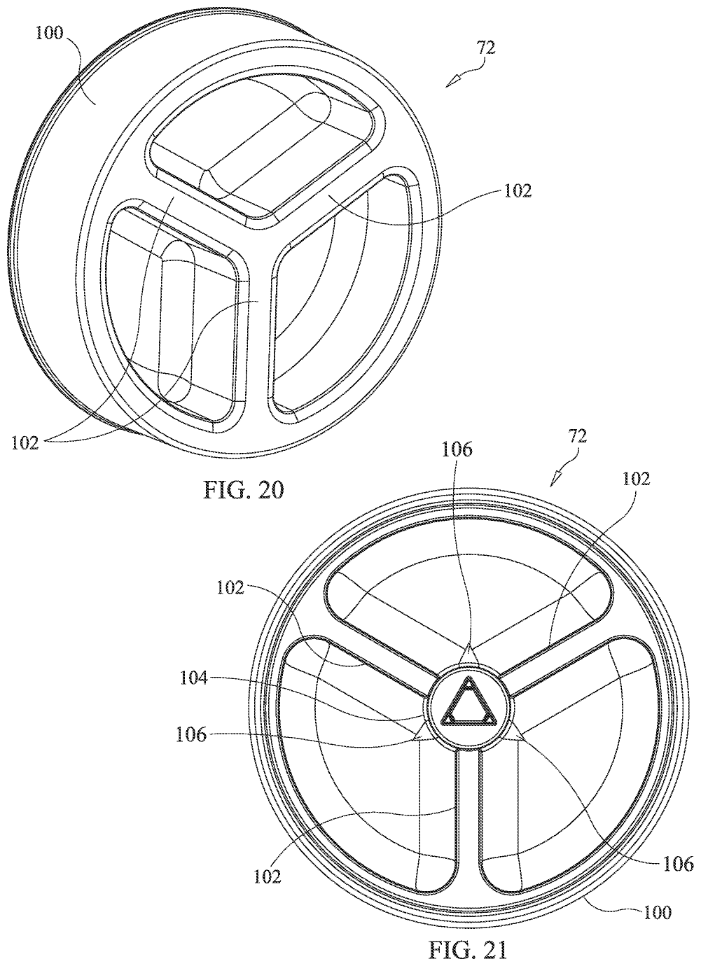

As shown in FIGS. 20-23, the knob 72 has an overall cylindrical or round or wheel shape. An outer circumferential surface 100 can include ribbing or a rough finish for easy gripping by a pet owner, a plurality of spoke-like projections 102 that extend radially outward on an outboard surface of the knob 72, a shaft attachment portion 104 centered and extending from an inboard surface of the knob 72 and projections 106.

The shaft attachment portion 104 of the knob 72 is provided with a geometric shape, such as a triangle shape (FIG. 21) that mates with the triangle shape of the second end 82 of the shaft 70 (FIGS. 15-16). The knob 72 can be fixed to the shaft 70 via a mechanical fastener or a snap-fitting engagement therebetween. The knob 72 is preferably rotated in a clockwise direction relative to the views in FIGS. 1, 2 and 15.

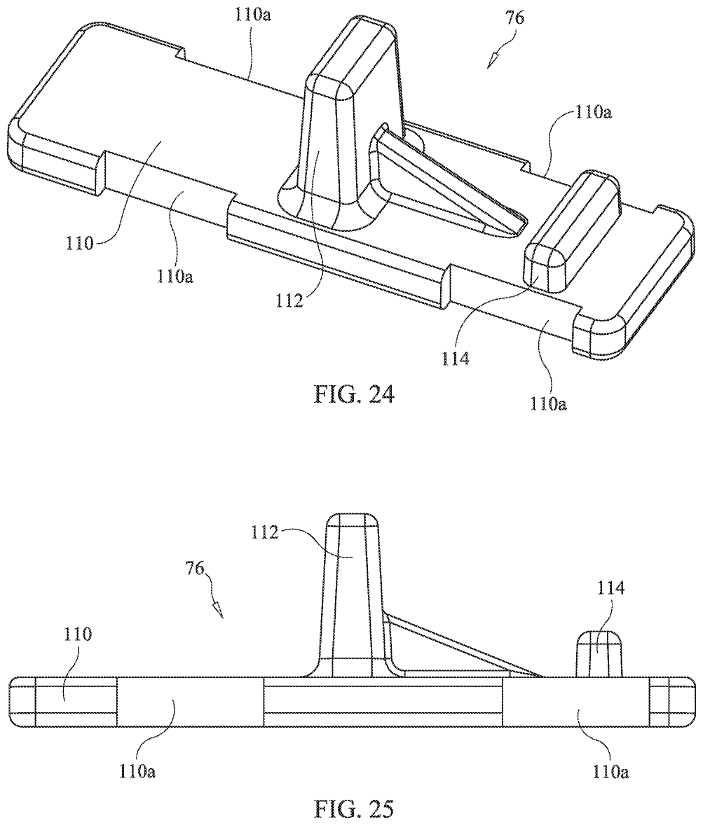

As shown in FIGS. 24 and 25, the shaft lock 76 is a rigid member having a flat main portion 110, a handle protrusion 112 and a safety portion 114. The shaft lock 76 is dimensioned to fit within the lock receiving recess 44 of the top surface 34 of the base 14, as shown in FIGS. 10-12.

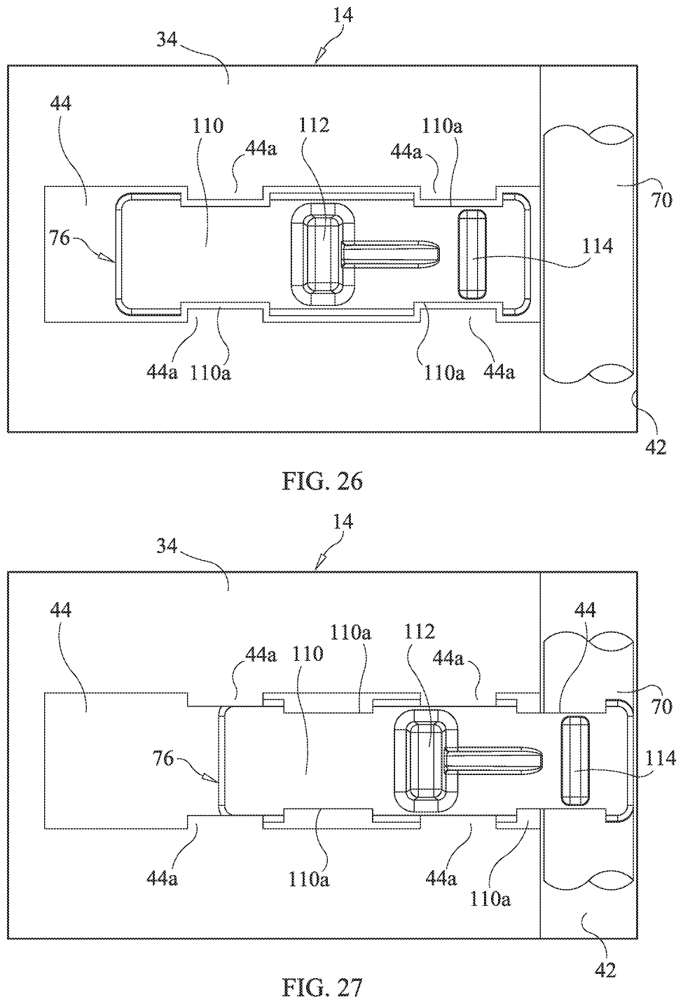

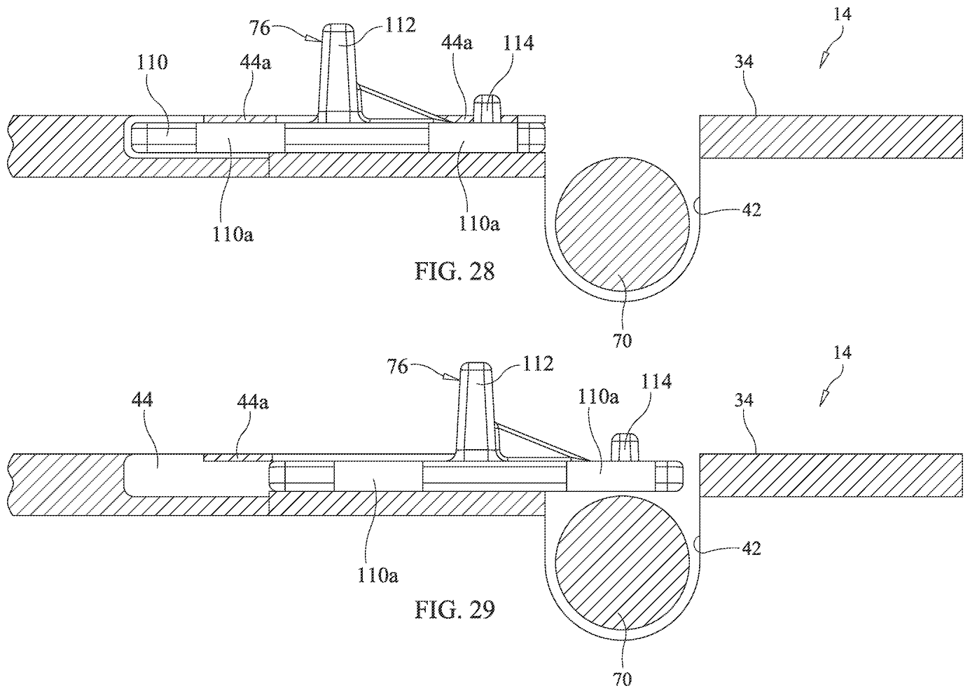

Once installed to the base 14, the shaft lock 76 can manually slide between a release position (FIGS. 26 and 28) and a lock position (FIGS. 27 and 29). A pet owner can move the shaft lock 76 by pushing on the handle protrusion 112. In the release position, the shaft 70 and spinner 74 are easily removed from the base 14. In the lock position (FIGS. 27 and 29), one end of the flat main portion 110 extends over the locking area 92 of the shaft 70 preventing upward movement of the shaft 70, the spinner 74 and the knob 72. The shaft 70 is able to rotate but upward movement of the shaft 70 is restricted or prevented by the main portion 110.

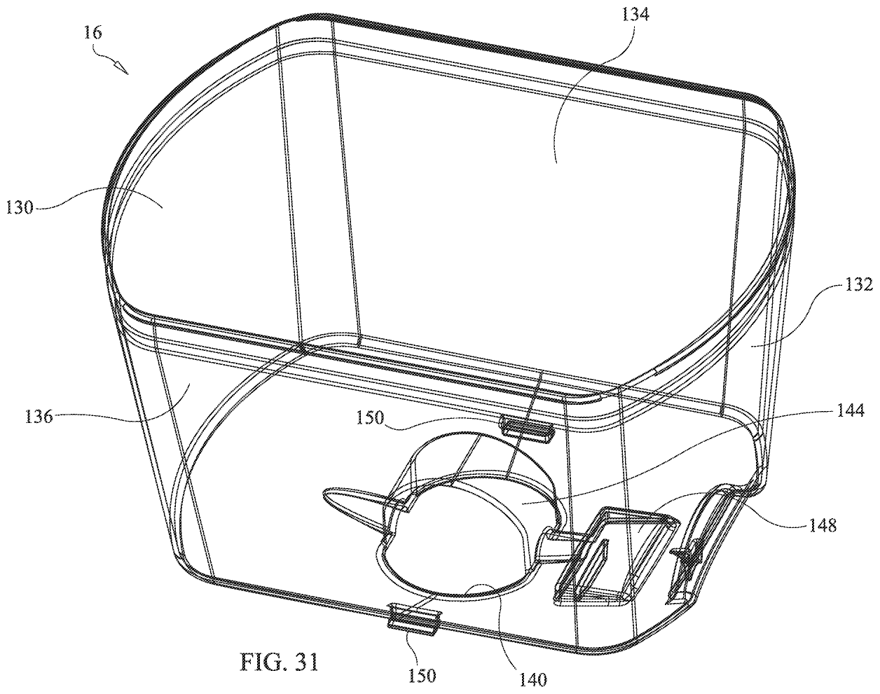

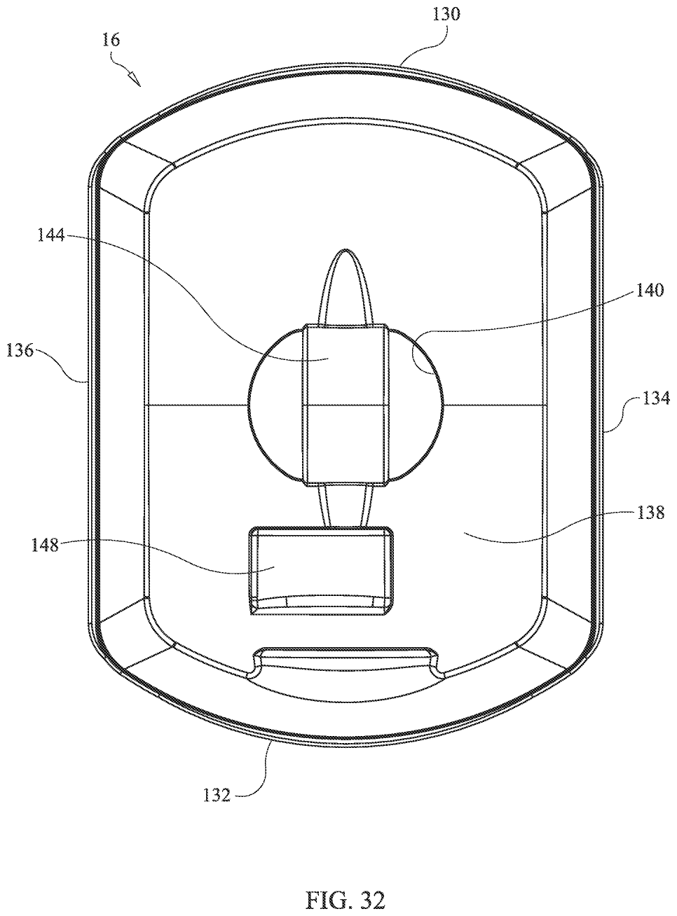

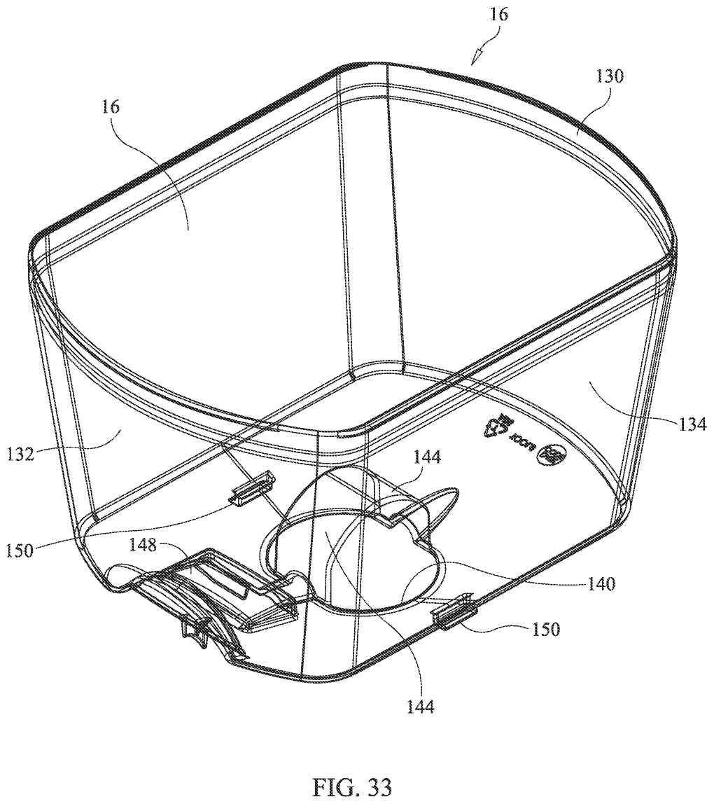

The handle protrusion 112 and the safety portion 114 of the shaft lock 76 are dimensioned such that with the shaft lock 76 in the release position, the hopper 16 is prevented from being fully installed to the base 14 due to the dimensioning and location of a safety lip 148 at the bottom of the hopper 16 (see FIGS. 1, 8, 14 and 31-33). With the shaft lock 76 in the lock position, the hopper 16 has a recessed area defined under the safety lip 148 that is dimensioned to receive the handle protrusion 112 and the safety portion 114 of the shaft lock 76 such that the hopper 16 rests evenly over the base 14. Hence, if the shaft lock 76 is not m the in the lock position, the safety lip 148 is not positioned over the handle protrusion 112 and the safety portion 114 thereby creating an interfere between the hopper 16 and the base 14 such that the hopper 16 does not sit flat or evenly over the base 14,

As shown in FIGS. 26 and 27, the flat main portion 110 of the shaft lock 76 includes four recesses 110a. The top surface 34 includes protrusions 44a with extend over the lock receiving recess 44. As shown in FIGS. 26 and 28, when the shaft lock 76 is in the release position, the shaft lock 76 can be removed from the recess 44 for cleaning. With the shaft lock 76 in the lock position (FIGS. 27 and 29) the protrusions 44a retain the shaft lock 76 within the lock receiving recess 44.

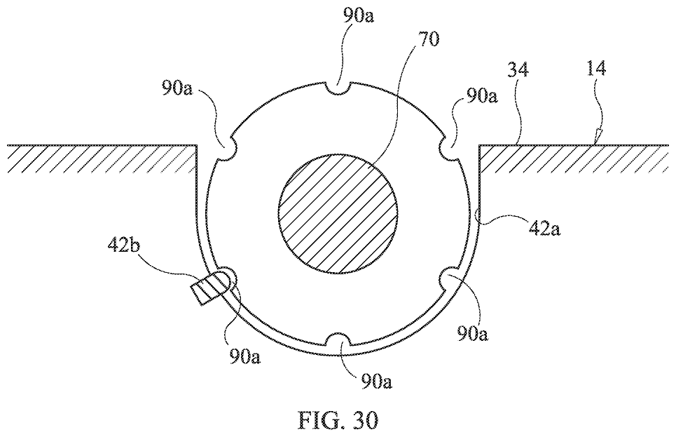

As mentioned above, the shaft 70 includes a wheel 90 (also referred to as a boss 90) that is rigidly fixed to the shaft 70. The wheel 90 is integrally formed there with or overmolded to the shaft 70. Regardless of how the shaft 70 and wheel 90 are manufactured, they rotate as a single element about the axis A₁. As shown in FIG. 30, with the shaft 70 installed to the base 14, the wheel 90 is located within recessed area 42a of the shaft receiving portion 42. The recessed area 42a includes a flexible projection 42b that is positioned within the recessed area 42a to contact the wheel 90, as shown in FIG. 30. The flexible projection 42b is preferably made of a flexible material such as rubber or rubber like material.

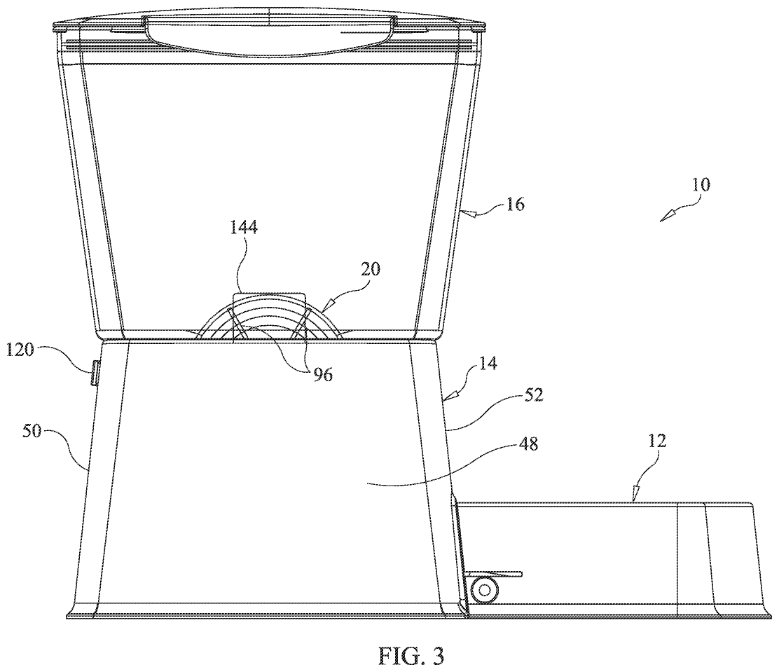

As shown in FIG. 30, the wheel 90 includes six (6) recesses 92a that are dimensioned to receive the flexible projection 42b. As the shaft 70 is rotated, the flexible projection 42b limits or restricts movement of the wheel 90 and the shaft 70 when the flexible projection 42b is in one of the recesses 92a. Rotational force applied by a pet owner to the knob 72 easily overcomes the force applied by the flexible projection 42b to the recesses 90a of the wheel 90. However, when no rotational force is being applied to the knob 72 with the flexible projection 42b being within one of the recesses 90a, the shaft 70 and spinner 74 are held in position. The recesses 90a are positioned relative to correspond to fins 96 of the spinner 74 such that with the flexible projection 42b located in one of the recesses 90a the fins 96 are retained in the orientation depicted in FIGS. 3 and 12-13. In FIGS. 3 and 12-13, two opposing fins 96 block and cover the spinner receiving portion 38 thereby preventing any foodstuff from passing the two opposing fins 96. The orientation of the two opposing fins 96 in FIGS. 3, 12 and 13 is referred to hereinafter as a sealing position, sealing the contents of the hopper 16 from the base 14.

The fins 96 are rotatable with respect to the hopper 16 between a dispensing position and the above defined sealing position. The fins 96 are positioned to block the opening 66 when in the sealing position, That is, the fins 96 block foodstuffs from exiting the hopper 16 when in the sealing position. The shaft 70 rotates to rotate the fins 96 into the dispensing position (positions other than the sealing position) that allows foodstuffs to be delivered from the hopper 16 to the bowl 12.

As shown in FIG. 15, the first side wall 46 of the base 14 includes the knob receiving section 58, which further includes the clicker receiving section 60. As mentioned above, the knob 72 includes three projections 106. As the knob 72 is rotated, one of the projections 106 circles past a distal end 78a of the clicker 78 thereby making a noise for the pet owner indicating that a predetermined amount of foodstuff has be released from the fins 96 of the spinner 74. The three projections 106 of the knob 72 are positioned in alignment or timed with alternating ones of the six recesses 92a of the wheel 90 (boss 90) of the shaft 70. In other words, when the shaft 70 is rotated, for every two times the flexible projection 42b engages a first and then a second one of the recesses 92a, the clicker 78 makes a noise due to contact with a passing one of the projections 106 of the knob 72. Thus, the pet owner operating the knob 72 is alerted to the release of a predetermined amount of foodstuff from two adjacent spaces between three fins 96.

The base 14 also includes a slide lock 120 that is received in a lock receiving area 124 of the base 14 (FIG. 11). Both the slide lock 120 and the lock receiving area 124 are described in greater detail below following the description of the hopper 16.

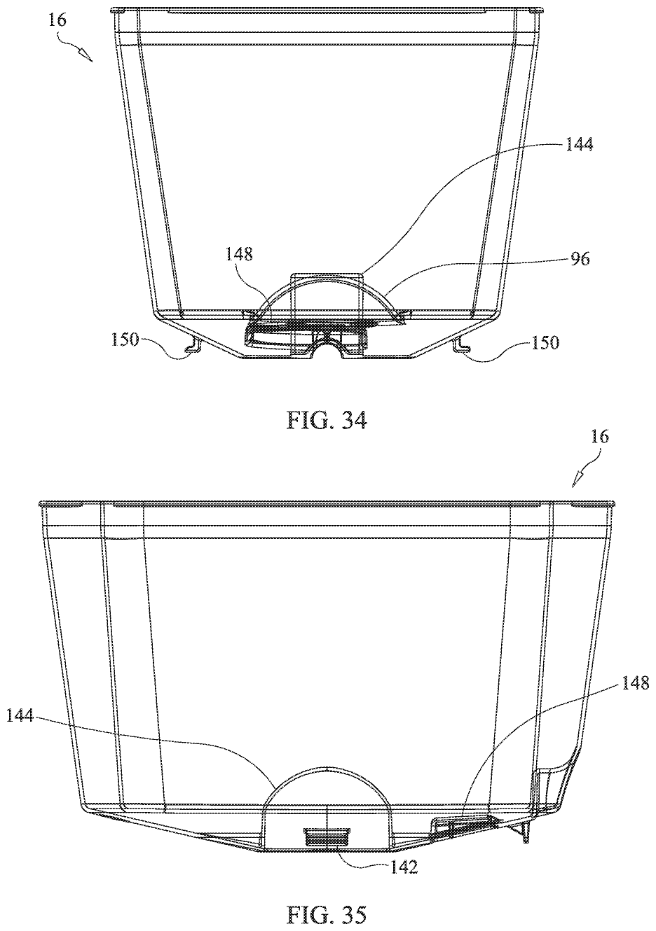

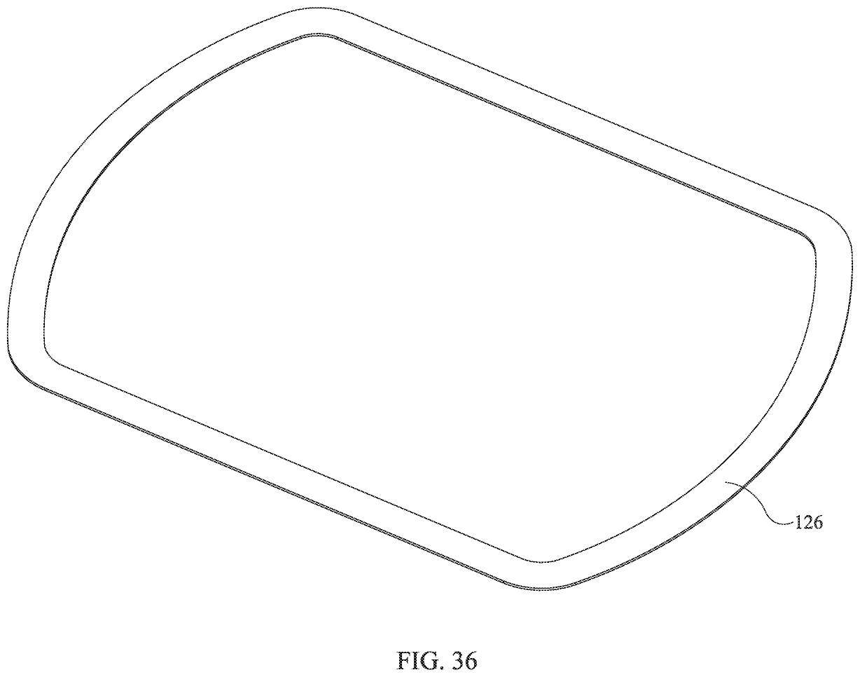

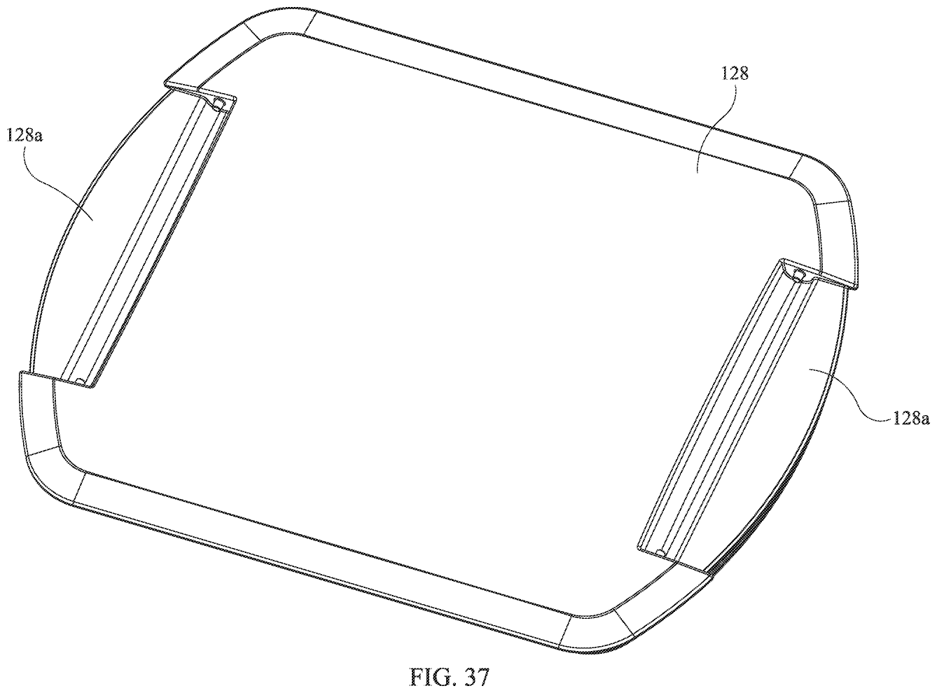

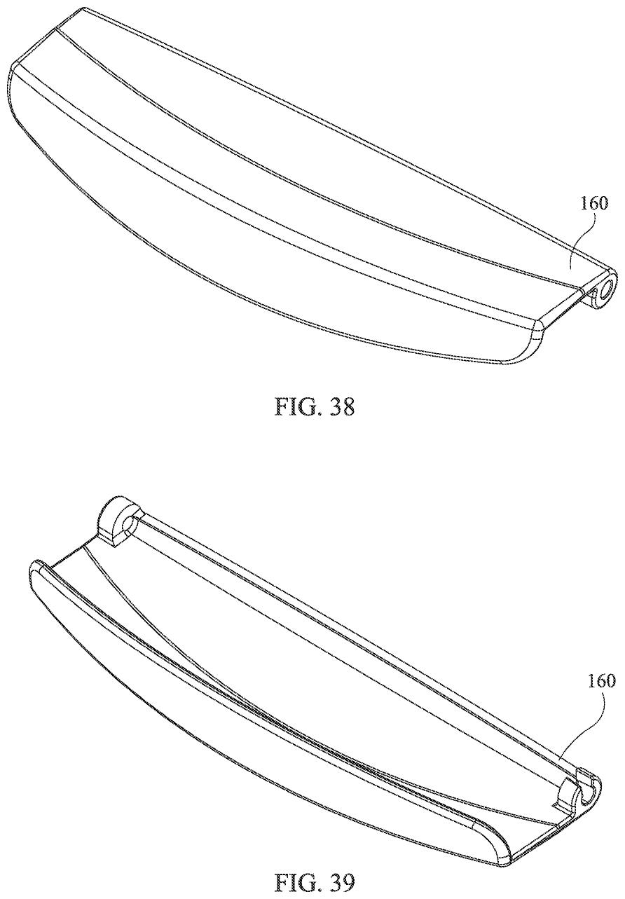

A description of the hopper 16 is now provided with reference to FIGS. 1-5, 8, 13-14 and 31-39. As shown in FIG. 8, the Koper 16 includes a gasket 126 (FIG. 36) and a lid 128 (FIG. 37).

The hopper 16 is dimensioned and manufactured for holding foodstuffs. The hopper 16 is also dimensioned and configured to be detachably supported to the base 14. The hopper 16 is preferably transparent and can be made of plastic, polymers, ceramic materials, stainless steel, fabric or glass. Preferably, the hopper 16 is plastic provided with a high polished surface. The hopper 16 can have an approximate volume of 20 to 30 cups. Preferably, the hopper 16 can hold approximately 25 cups of foodstuffs. The hopper 16 preferably includes indicia or indications (not shown) such as engraving to indicate the amount of foodstuffs that is being stored in the hopper 16. The hopper 16 includes sidewalls 130 and 132, a rear wall 134 a front wall 136 and a floor or bottom wall 138 that are all formed together or attached to one another defining an interior storage space for the foodstuff. The bottom wall 138 has a first opening 140 that accommodates the food dispensing mechanism 20. The hopper 16 also includes an overfeed barrier 144 that is a wall extending from one side of the opening 140. The overfeed harrier 144 partially blocks foodstuffs from overflowing from the hopper 16 to the bowl 12.

The first opening 140 (also referred to as a spinner opening) is part of an overall portion control that limits the amount of foodstuff that can pass through the first opening 138 and subsequently down to the bowl 12. As shown in FIGS. 1-5, 8, 13-15, 31-35 and 43, an overfeed barrier 144 extends over a portion of the first opening 138 and the spinner 74. The overfeed barrier 144 has a partial annular shape and extends arcuately in a direction parallel to the axis A₁. However, the imaginary center of the annular shape is perpendicular to the axis A₁.

The arcuate shape of the overfeed barrier 144 is such that a small gap is defined between an inner surface of the overfeed barrier 144 and outer edges of the fins 96 of the spinner 74. Thus, there is no interference between the rotation of the spinner 74 and the overfeed barrier 144,

The overfeed barrier 144 is sized and dimensioned such that only two fins 96 receive foodstuffs from the hopper 16 at a time. When the fins 96 are rotated, the foodstuffs F are released from the fins 96 incrementally via two fins 96 at a time. The fins 96 can then be rotated to seal or block the first opening 140 to prevent additional food from being dispensed. In this way, the food dispensing mechanism 20 moves from dispensing position to sealing position and so on as the shaft 70 and the fins 96 rotate.

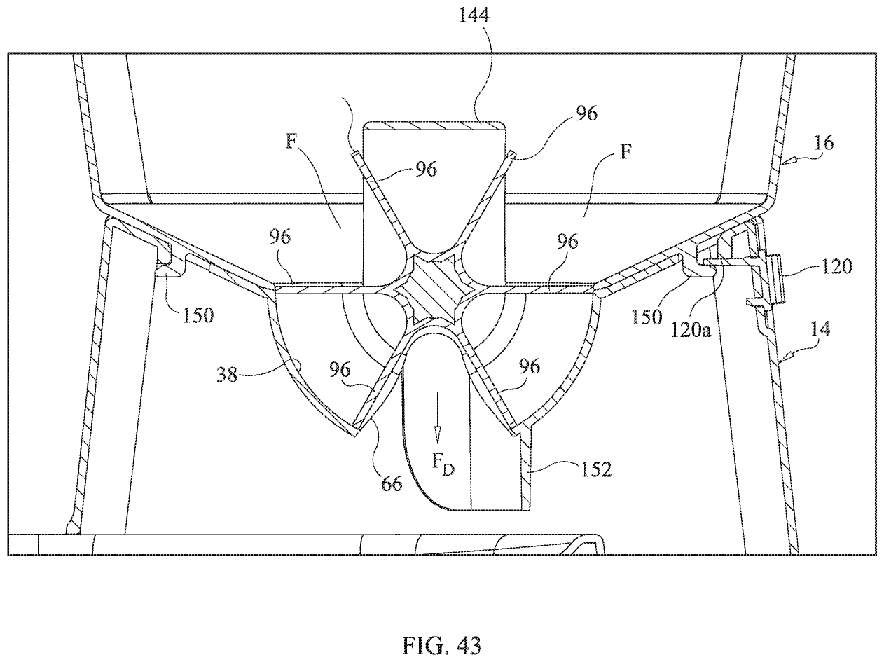

As shown in FIGS. 13-14 and 43, below the first opening 140, there is a vertical wall section or containment wall 152 that can be part of the base 14 or part of the hopper 16. The containment wall 152 ensures that dispensed food FD falls from the spaces between the lowermost fins 86 of the lower spinner 74 and into the bowl 12, as shown in FIG. 43.

The hopper 16 attaches to the top of the base 14 in a manner described below.

First, the shaft lock 76 must be in the lock position retaining the shaft 70 of the food dispensing mechanism 20 within the shaft receiving portions 40 and 42 of the base 14. With the shaft lock 76 locked, the handle protrusion. 112 and the safety portion 114 of the shaft lock 76 are clear of the safety lip 148 and the hopper 16 can be seated properly on the base 14. In other words, the handle protrusion 112 and the safety portion 114 of the shaft lock 76 do not interfere with the safety lip 148 allowing the bottom edge of the hopper 16 to be flush with upper edge of the base 14.

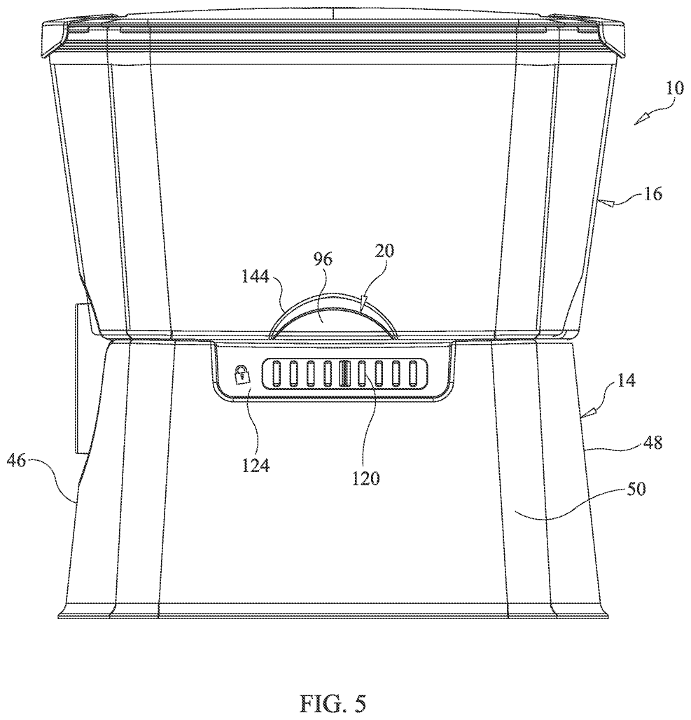

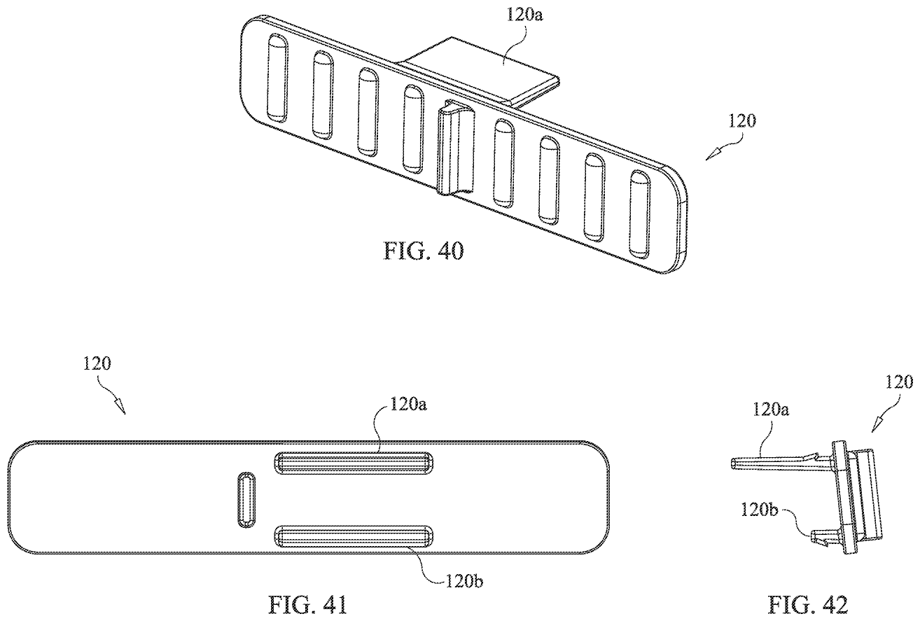

As shown in FIGS. 5, 7, 11 and 40-43, the slide lock 120 includes a tab or first projection 120a and a second projection 120b. The first projection 120a extends further that the second projection 120b from the main body of the slide lock 120. Each of the first and second projections 120a and 120b includes a retaining barb or projection (small), as shown in FIG. 42. The first and second projections 120a and 120b are inserted into slots 124a and 124b of the lock receiving area 124 of the base 14 (shown in FIG. 11). Once inserted, the barbs of the first and second projections 120a and 120b retain the slide lock 120 to the base 14 for sliding movement along the slots 124a and 124b. As shown in FIG. 43, with the slide lock 120 slide to a lock position, the projection 120a extends over a portion of a rearward one of a pair of base contacting hooks 150 that extend downward from the bottom wall or floor 138 of the hopper 16 into the latch opening 64 thereby attaching the hopper 16 to the base 14. The other of the base contacting 150 extends through the latch opening 62 hooking onto the base 14. Thus, with the rearward one of the base contacting hooks 150 locked in place by the projection 120a, the hopper 16 is held in place to the base 14.

As seen in FIG. 12, the feeder 10 further includes the lid 128 that is to be provided over the hopper 16 and the gasket 126 that is positioned between the lid 128 and the hopper 16 to seal the hopper 16 of the feeder 10. The feeder 10 further includes a pair of lid hatches 160 disposed on either side of the lid 128 within recesses 128a. The lid 128 latches 160 are pivotally connected to the lid 128 between a closed and an open state in a conventional manner. The lid latches 160 are snap fitted to the hopper 16 When the lid latches 160 are in the closed state. The lid latches 160 can be pivoted to be released from the hopper 16 and lifted from the lid 128,

The gasket 126 is preferably an elastic seal that is sized and dimensioned to correspond to fit to a top edge of the hopper 16. The gasket 126 is preferably made of die cut rubber.

### General Interpretation of Terms

In understanding the scope of the present invention, the term “comprising” and its derivatives, as used herein, are intended to be open ended terms that specify the presence of the stated features, elements, components and/or groups, but do not exclude the presence of other unstated features, elements, components and/or groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a feeder. Accordingly, these terms, as utilized to describe the present invention should be interpreted relative to the feeder.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time, Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A pet food feeder, comprising:
a base;
a hopper for holding foodstuffs, the hopper being detachably supported to the base;
a bowl for receiving foodstuffs from the hopper via the base; and
a food dispensing mechanism, the food dispensing mechanism being supported to the base, the food dispensing mechanism being rotatable with respect to the base to dispense foodstuffs from the hopper to the bowl in predetermined increments.

2. The pet food feeder in accordance with claim 1, wherein
the food dispensing mechanism includes a shaft and a plurality of fins, the plurality of fins being supported to the shaft so to rotate concurrently with the shall.

3. The pet food feeder in accordance with claim 2, wherein
the shall is detachably fixed to the base at a first position and a second position, the first and second positions being disposed at opposite sides of the plurality of fins.

4. The pet food feeder in accordance with claim 3, wherein
the food dispensing mechanism further includes a shaft lock positioned at the first position, the shaft lock being operatively connected to the base and to the shaft to prevent radial movement of the shaft with respect to a pivot axis of the shaft.

5. The pet food feeder in accordance with claim 3, wherein
the food dispensing mechanism further includes a noise maker positioned at the second position, the noise maker producing a sound indication at the predetermined increments of dispensing the foodstuffs.

6. The pet food feeder in accordance with claim 5, wherein
the food dispensing mechanism further includes a knob operatively coupled to the shaft, the knob being operable to rotate the shaft.

7. The pet food feeder in accordance with claim 2, wherein
the hopper including an opening that accommodates the fins, the tins being rotatable with respect to the hopper between a dispensing position and a sealing position, the fins blocking the opening when in the sealing position.

8. The pet food feeder in accordance with claim 7, wherein
the hopper includes a overfeed barrier that is a wall extending from one side of the opening, the overfeed barrier partially blocking foodstuffs from contacting the fins such that at most two adjacent pairs of fins are contacting foodstuffs at one time.
